(19) United States
(12) Patent Application Publication
(10) Pub. No.: US 2019/0119965 A1
(43) Pub. Date: Apr. 25, 2019

(54) Method and Apparatus for Preventing a Vehicle Closure Member from Closing in Response to Detected Obstruction

(71) Applicant: FORD GLOBAL TECHNOLOGIES, LLC, Dearborn, MI (US)

(72) Inventors: Carlos Hernandez, Ciudad de Mexico (MX); Jaime Avalos Rios, Naucalpan (MX); Alvaro Jimenez Hernandez, MIGUEL HIDALGO (MX); Juan Jose Bustos, Naucalpan (MX)

(21) Appl. No.: 15/791,489

(22) Filed: Oct. 24, 2017

(51) Int. Cl. E05C 17/00; E05B 81/20

(52) U.S. Cl. CPC E05C 17/025; E05Y 2201/232; E05Y 2900/531; E05B 81/21

(57) ABSTRACT

An apparatus, according to an exemplary aspect of the present disclosure includes, among other things, a first vehicle structure mounted for movement relative to a second vehicle structure between open and closed positions, and a sensing strip placed to surround a substantial portion of at least one of the first and second vehicle structures to detect an obstruction. At least one actuator prevents the first vehicle structure from moving to the closed position in response to a detected obstruction.

### TECHNICAL FIELD

This disclosure relates to an exemplary apparatus and method of preventing closure of a vehicle closure member in response to a detected obstruction.

### BACKGROUND

Vehicles include various closure members such as doors, windows, trunk lids, liftgates, etc. The closure member is mounted for movement relative to a fixed vehicle frame structure and is movable between open and closed positions. As a closure member moves toward the closed position, obstructions such as fingers, hands, feet, etc. can be pinched or can become trapped between the closure member and frame structure. Systems are needed to detect obstructions and prevent closure of the closure member in response to detected obstructions to avoid injury.

### SUMMARY

An apparatus according to an exemplary aspect of the present disclosure includes, among other things, a first vehicle structure mounted for movement relative to a second vehicle structure between open and closed positions, and a sensing strip placed to surround a substantial portion of at least one of the first and second vehicle structures to detect an obstruction. At least one actuator prevents the first vehicle structure from moving to the closed position in response to a detected obstruction.

In a further non-limiting embodiment of the foregoing apparatus, the sensing strip comprises a flexible strip of electrodes that detects the obstruction based on projected capacitance.

In a further non-limiting embodiment of either of the foregoing apparatus, the sensing strip can detect obstructions without the obstruction contacting the sensing strip.

In a further non-limiting embodiment of any of the foregoing apparatus, the sensing strip is pressure sensitive.

In a further non-limiting embodiment of any of the foregoing apparatus, the first vehicle structure comprises a closure panel and the second vehicle structure comprises a frame, and wherein the sensing strip extends along at least two connected outer edges of the closure panel and/or along at least two connected outer edges of the frame.

In a further non-limiting embodiment of any of the foregoing apparatus, the at least one actuator comprises a linear actuator that moves at least one bump stop to a deployed position in response to the detected obstruction.

In a further non-limiting embodiment of any of the foregoing apparatus, the at least one actuator comprises at least one electromagnetic damper.

In a further non-limiting embodiment of any of the foregoing apparatus, the electromagnetic damper comprises a hinge that couples the first and second vehicle structures together.

In a further non-limiting embodiment of any of the foregoing apparatus, a control unit receives signals from the sensing strip and generates control signals to control actuation of the actuator, and wherein the control unit immediately deploys the actuator in response to a detected obstruction.

An apparatus according to another exemplary aspect of the present disclosure includes, among other things, a vehicle panel that is movable relative to a frame between open and closed positions, and a sensing strip that extends along an outer edge of at least one of the vehicle panel and frame to detect an obstruction between the panel and frame, and at least one actuator that is immediately deployed in response to a detected obstruction to prevent the panel from moving to the closed position.

In a further non-limiting embodiment of any of the foregoing apparatus, the sensing strip comprises a flexible strip of electrodes that detects the obstruction based on projected capacitance.

In a further non-limiting embodiment of any of the foregoing apparatus, a control unit receives signals from the sensing strip and generates control signals to control actuation of the actuator.

In a further non-limiting embodiment of any of the foregoing apparatus, the at least one actuator comprises a linear actuator that moves at least one bump stop to a deployed position in response to the detected obstruction.

In a further non-limiting embodiment of any of the foregoing apparatus, the at least one actuator comprises at least one electromagnetic damper.

In a further non-limiting embodiment of any of the foregoing apparatus, each of the panel and frame include an upper edge, lower edge, and side edges connecting the upper and lower edges, and wherein the sensing strip extends along at least the upper edge and one of the side edges of at least one of the panel and frame.

A method according to another exemplary aspect of the present disclosure includes the steps of, among other things: mounting a vehicle panel for movement relative to a frame between open and closed positions, surrounding outer edges of at least one of the vehicle panel and frame with a sensing strip to detect an obstruction between the panel and frame, and immediately actuating an actuator in response to a detected obstruction to prevent the panel from moving to the closed position.

In a further non-limiting embodiment of the foregoing method, the sensing strip comprises a flexible strip of electrodes that detects the obstruction based on projected capacitance, and including extending the sensing strip along at least two connected outer edges of the panel and/or along at least two connected outer edges of the frame.

In a further non-limiting embodiment of either of the foregoing methods, the method includes transmitting sensor signals to a control unit and generating control signals to control the actuator in response to an absence and/or presence of an obstruction.

In a further non-limiting embodiment of any of the foregoing methods, the at least one actuator comprises a linear actuator that moves at least one bump stop to a deployed position in response to the detected obstruction.

In a further non-limiting embodiment of any of the foregoing methods, the at least one actuator comprises at least one electromagnetic damper.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a perspective view of a vehicle door and pillar.

FIG. 2 is a schematic representation of a control system to prevent door closure in response to a detected obstruction.

FIG. 3 is a perspective view of one example of a sensing strip.

FIG. 4 shows a schematic representation of sensing strip installation locations.

FIG. 5 is a perspective view of one example of an actuator.

FIG. 6 is a perspective view of the actuator as used in FIG. 5.

FIG. 7A is a perspective view of a door showing one example of bump stop locations.

FIG. 7B is a schematic representation of the bump stops of FIG. 5 in a retracted position.

FIG. 7C is a schematic representation of the bump stops of FIG. 5 in a deployed position.

FIG. 8 shows an example of the steps of the method of deploying the bump stops.

FIG. 9 shows another example of an actuator.

FIG. 10A is a schematic representation of the actuator of FIG. 9 in a retracted position.

FIG. 10B is a schematic representation of the actuator of FIG. 9 in a deployed position.

### DETAILED DESCRIPTION

This disclosure details exemplary apparatus and methods of preventing closure of a vehicle closure member in response to a detected obstruction.

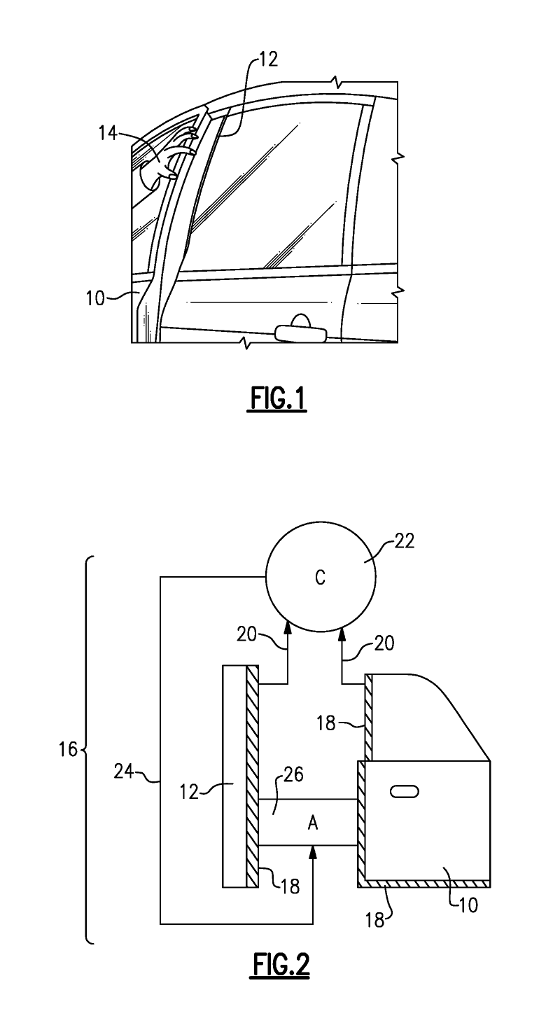

Vehicles include various closure elements such as doors, windows, trunk lids, liftgates, etc. In one example shown in FIG. 1, a vehicle includes a door 10 that is mounted for movement relative to a fixed vehicle structure such as a frame or pillar 12. The door 10 is movable between an open position to allow ingress and egress from the vehicle and a closed position. As the door 10 moves toward the closed position, an obstruction 14 such as a hand or finger for example, can be pinched or trapped between the door 10 and the pillar 12.

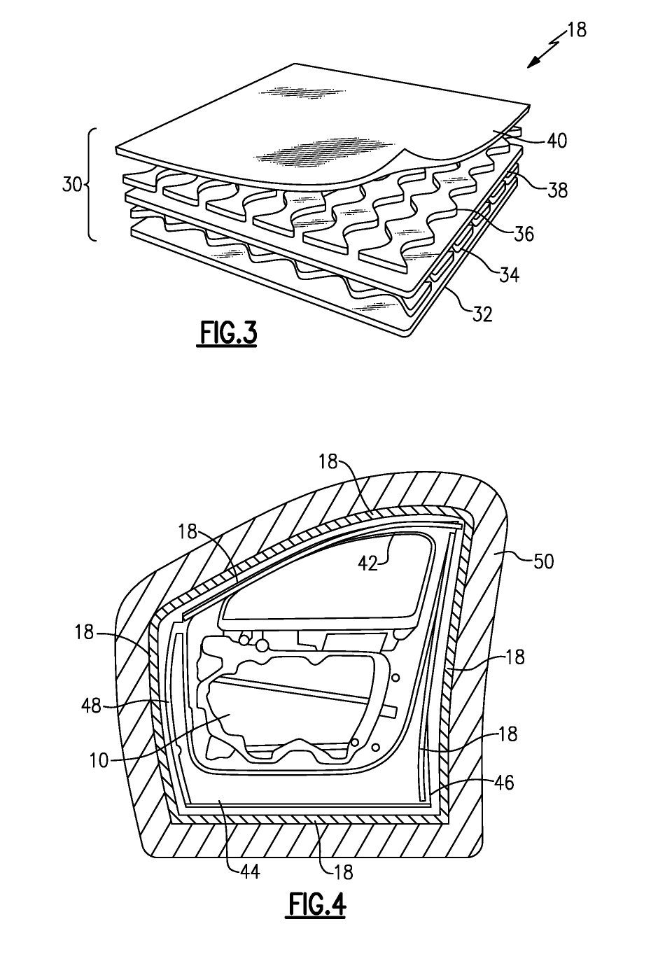

In one example, a control system 16 (FIG. 2) is used to detect obstructions and generate control signals to control movement of the door 10 in relation to the pillar 12 to avoid injury once an obstruction is detected. The control system 16 includes a plurality of sensors in the form of a sensing strip 18 that is placed to surround a substantial portion of at least one of the door 10 and pillar 12. The sensing strip 18 can be positioned to lay along the entirety of the pillar 12 and any remaining portion of the fixed frame that surrounds the door 10, or around an entirety of an outer edge of the door 10. Optionally, the sensing strip 18 can be placed along both the pillar 12 and the door 10. Sensor signals 20 are sent to a control unit 22 that processes the signals and generates a control signal 24 to deploy one or more actuators 26 to prevent the door 10 from closing and crushing the detected obstruction.

The control unit 22 can include a processor, memory, and software programed to control the actuator 26. The control unit 22 can be a dedicated unit or part of an existing vehicle control unit and may be a hardware device for executing the software that is stored in memory. The control unit 22 can be a custom made or commercially available processor, a central processing unit (CPU), an auxiliary processor among several processors associated with the computing device, a semiconductor based microprocessor (in the form of a microchip or chip set) or generally any device for executing software instructions. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions.

The sensing strip 18 is shown in greater detail in FIG. 3. In one example, the sensing strip 18 comprises a layered sensor 30 that is made from tough and flexible electrodes in combination with a silicone polymer structure that makes the layered sensor 30 highly touch and pressure sensitive while still being stretchable and durable. In one example, the layered sensor 30 includes a protective insulating base layer 32, a polymer Y-electrode layer 34, a polymer X-electrode layer 36, a dielectric layer 38, and a protective top layer 40. The layered sensor 30 is based on projected capacitance such that conductive objects, such as a fingertip for example, can be detected even at a distance, i.e. in a non-contact position. The layered sensor 30 is pliable, which makes it easy to place the layered sensor 30 around a periphery of an object such as a frame or door. One example of a layered sensor 30 comprises sensorskin™ provided by Tacterion.

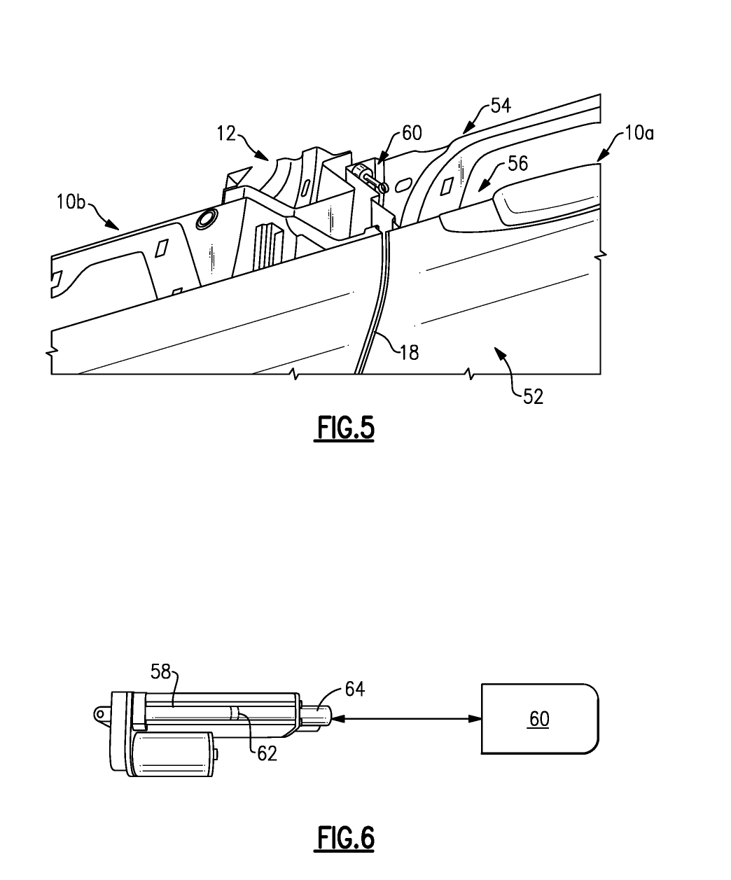

FIG. 4 shows one example of a door 10 having an upper edge 42, a lower edge 44, a first side edge 46, and a second side edge 48. The side edges 46, 48 connect the upper 42 and lower 44 edges. In one example, the sensing strip 18 extends along at least the first side edge 46 and the upper edge 42 to surround a substantial portion of the door 10, e.g. surrounds at least 50% of the periphery of the door 10. The sensing strip 18 may also be additionally extended along the lower edge 44 to surround a substantially greater portion of the door, e.g. to surround at least 75% of the periphery of the door 10. In another example, the sensing strip 18 may also be additionally extended along the second side edge 48 to surround an entirety of the door 10, e.g. to surround at least 100% of the periphery of the door 10. Similarly, a frame structure 50 that surrounds the door 10 can be configured to having a sensing strip 18 along two edges, three edges, and/or four or more edges. This can be in addition to, or in place of the sensing strip 18 on the door 10. As the sensing strip 18 can be installed all around the outer edge of the door 10 and/or frame structure 50, it does not matter where the hand is positioned while the door 10 is closing. The sensing strip 18 will detect the human obstruction and will avoid pinching the hand by actuating the actuator 26 to stop the door 10 from closing.

FIG. 5 shows one example of a sensing strip 18 that is installed between a front door 10a and a rear door 10b. The doors 10a, 10b are movable relative to the pillar 12 located between the doors 10a, 10b and are shown in the closed position. The front door 10a includes an outer panel 52 and an inner panel 54 that define an internal cavity 56 therebetween. In this example, the actuator 26 comprises one or more high speed linear actuators 58 coupled to one or more bump stops 60 that are located within the internal cavity 56. Locating the linear actuator 58 in the internal cavity 56 is beneficial as there are already existing door lock electric components in this area and thus the linear actuator 58 can be powered from a common power source with the door lock.

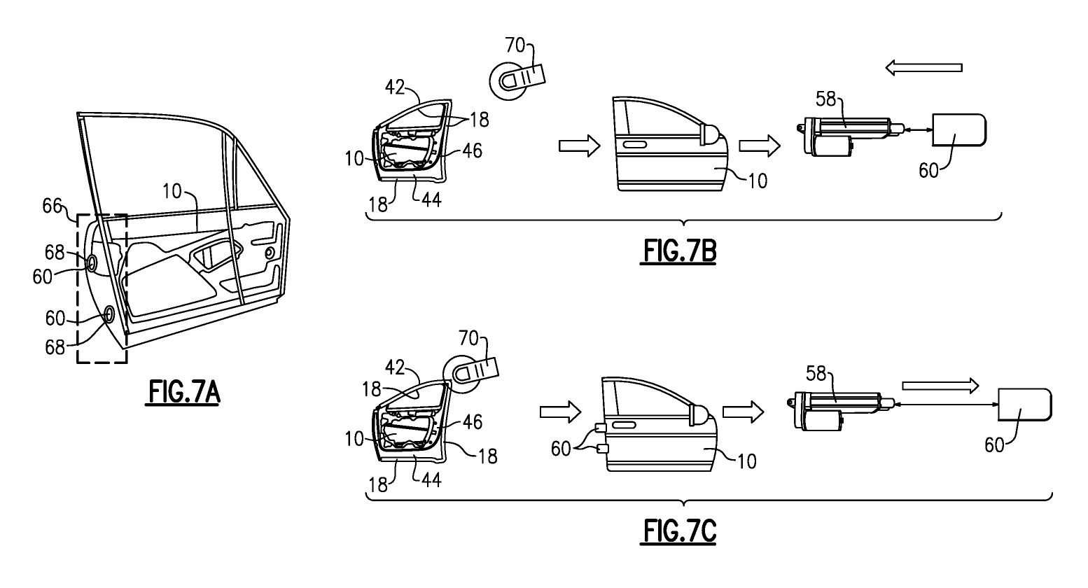

The linear actuator 58 moves the bump stop 60 between a retracted position and a deployed position. The linear actuator 58 is configured to operate similar to door lock actuators which extend and retract a piston 62 (shown schematically in FIG. 6) coupled to a rod 64. The piston/rod (62, 64) is connected to the bump stop 60 which is moved to the extended/deployed position to prevent the door 10a from being closed in response to a detected obstruction. In one example, the bumpers 60 are formed from a resilient soft material, such as foam for example, so that the vehicle is not damaged during deployment. Additionally, in one example, the size of the bump stop 60 is preferably larger than a standard human finger, and in one example is at least two inches in each dimension.

In one example, the bump stops 60 are deployed immediately when the sensing strip 18 detects a hand or finger. In other words, the door 10 itself does not have to be moving in a closing direction to initiate deployment. The door 10 can be open and stationary, and the bump stops 60 will be deployed as soon as the sensing strip 18 detects the presence of a hand or finger. Thus, the velocity of the activation of the linear actuator 58 is not as important because the bump stops 60 are immediately deployed once a human presence is detected at the edge of the door or frame. As such, the sensing strip 18 acts as an on/off switch for the bump stops 60.

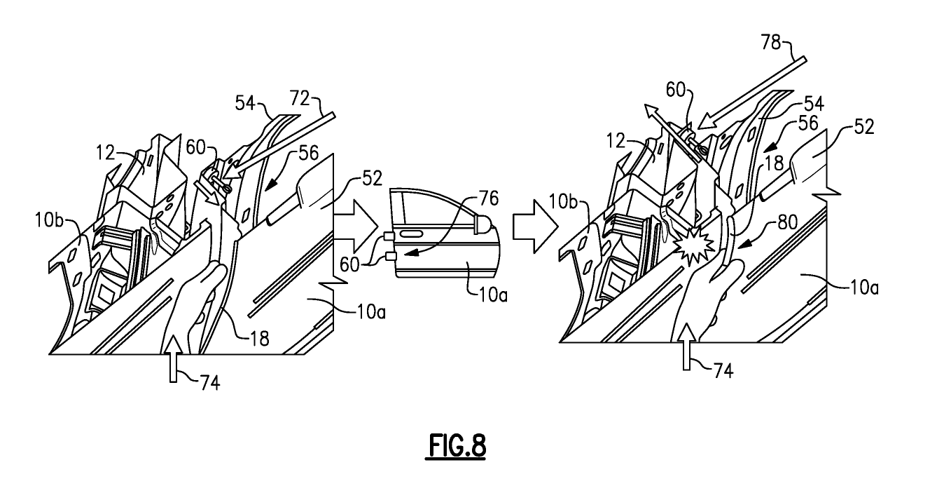

In one example shown in FIGS. 7A-C, one or more bump stops 60 are located in latch side 66 of the door 10. One hole/mount location 68 for each bump stop 60 is located in a door structure panel on the latch side 66. As shown in the example in FIGS. 7B and 7C, the sensing strip 18 extends along the top edge 42, side edge 46, and lower edge 44 of the door 10. FIG. 7B shows an example where a finger 70 is spaced away from the sensing strip 18, while FIG. 7C shows an example where the finger 70 is in close proximity to the sensing strip 18. As shown in FIG. 7B, when the finger 70 is spaced away from the sensing strip 18, the bump stops 60 are not visible from the exterior of the vehicle and the linear actuators 58 and associated bump stops 60 are retracted. As shown in FIG. 7C, when the finger 70 is proximate the sensing strip 18, the bump stops 60 are visible from the exterior as the linear actuators 58 have deployed the bump stops 60 such that the bump stops 60 will clash with a surrounding vehicle structure to avoid injury.

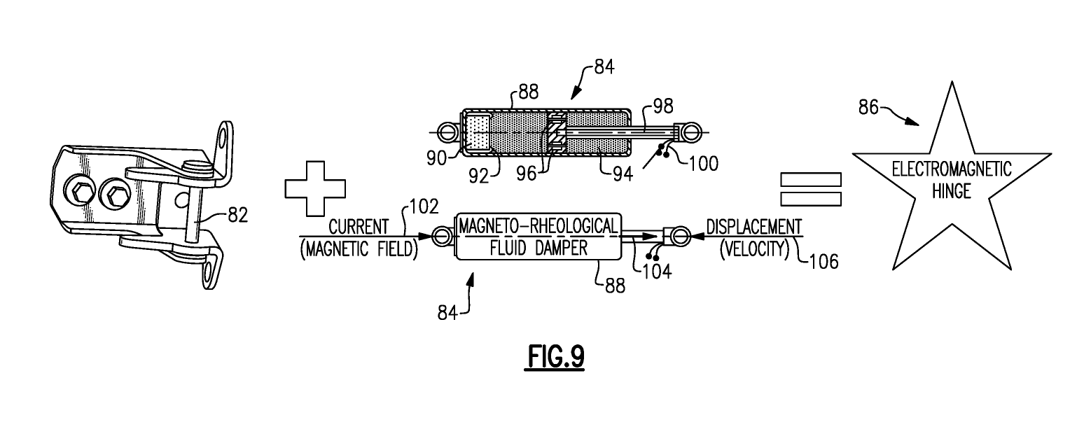

FIG. 8 shows an example of the steps of the method of deploying the bump stops 60. In this example, the bump stop 60 is mounted to the inner door panel 54 and is positioned within the internal cavity 56 when in the retracted position as indicated at 72. The front door 10a is open and a hand 74 is located in a gap between the front door 10a and the rear door 10b. As soon as the sensing strip 18 detects the presence of human skin, e.g. the hand 74, sensor signals 20 are transmitted to the control unit 22. The control unit 22 receives the sensor signals 20 and generates a control signal 24 to immediately deploy the bump stops 60 (as indicated at 76) in response to detection of the hand 74. When the bump stops 60 are deployed, the bump stop 60 extends outwardly from the internal cavity 56 to a position that is outwardly of the inner door panel 54 as indicated at 78. In this position, the bump stops 60 contact the pillar 12 to prevent the door 10a from closing, and the hand 74 is not pinched as indicated at 80. If the sensing strip 18 does not detect a human presence, the door 10a can be closed.

FIG. 9 shows another example of an actuator 26 that can be used to prevent the door 10 from closing in response to detection of a human presence. In this example, a hinge 82 is associated with an electromagnetic fluid-filled damper 84 to provide an electromagnetic hinge 86. The electromagnetic fluid-filled damper 84 includes an outer housing 88, an accumulator 90, and a diaphragm 92 separating the accumulator 90 from magneto-rheological (MR) fluid 94 located within an internal cavity of the housing 88. The electromagnetic fluid-filled damper 84 includes piston/coil assembly 96 coupled to a rod 98 that includes wires 100 to connect the piston/coil assembly 96 to a power source. Current 102 is applied to the electromagnetic fluid-filled damper 84 to generate a force 104 to control displacement/velocity 106 to act as a brake to prevent the door 10 from being closed.

In one example, the damper 84 is configured to selectively modulate a fluid flow rate corresponding to a closing rate of the door 10a dependent on a magnetic field corresponding to the output signal of electronic processor of the control unit 22 that is associated with the sensing strip 18. As such, with the sensing strip 18 and the control unit 22, the magnetic fluid can be controlled in order to stop the door 10a to prevent fingers from being pinched. Similar to the linear actuator with the bump stops described above, the activation velocity of the electromagnetic braking damper 84 is not as important because the electromagnetic brake will be immediately activated upon detection of a human presence. Thus, the damper 84 acts as an on/off button.

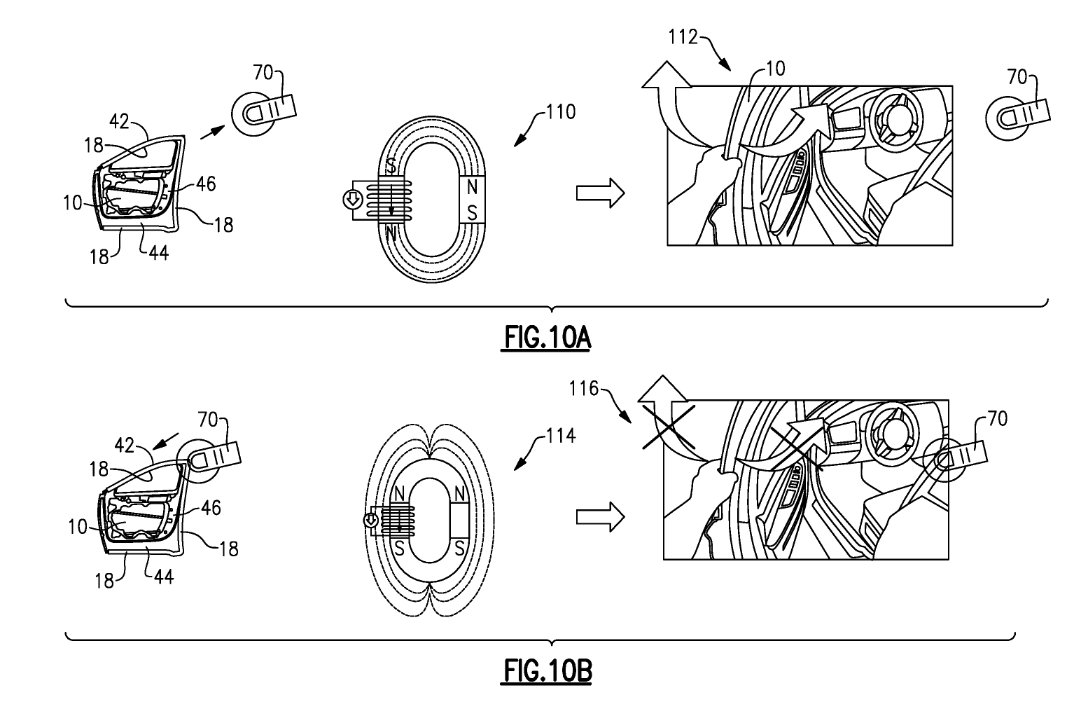

FIGS. 10A-B show an example where the sensing strip 18 extends along the top edge 42, side edge 46, and lower edge 44 of the door 10. FIG. 10A shows an example where the finger 70 is spaced away from the sensing strip 18, while FIG. 10B shows an example where the finger 70 is in close proximity to the sensing strip 18. As shown in FIG. 10A, when the finger 70 is spaced away from the sensing strip 18, the magnetic field is deactivated as indicated at 110. In this state, the door 10 is free to move as indicated at 112. As shown in FIG. 10B, when the finger 70 is proximate the sensing strip 18, the magnetic field is activated as indicated at 114. In this state, the door 10 is held fixed as indicated at 116 and the door 10 cannot be closed such that injury to the finger 70 is avoided.

The subject invention provides a system that prevents injuries to appendages such as fingers, hands, etc. by preventing closure movement when a human obstruction is detected. The position of the obstruction does not matter as the system utilizes a sensor strip that extends along the outer edge of the closure element and/or associated frame. Further, the actuators, such as the linear actuator or damper for example, are immediately deployed upon obstruction detection such that injury is easily avoided.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An apparatus, comprising:
a first vehicle structure mounted for movement relative to a second vehicle structure between open and closed positions;
a sensing strip placed to surround a substantial portion of at least one of the first and second vehicle structures to detect an obstruction; and
at least one actuator that prevents the first vehicle structure from moving to the closed position in response to a detected obstruction.

2. The apparatus according to claim 1, wherein the sensing strip comprises a flexible strip of electrodes that detects the obstruction based on projected capacitance.

3. The apparatus according to claim 2, wherein the sensing strip can detect obstructions without the obstruction contacting the sensing strip.

4. The apparatus according to claim 2, wherein the sensing strip is pressure sensitive.

5. The apparatus according to claim 2, wherein the first vehicle structure comprises a closure panel and the second vehicle structure comprises a frame, and wherein the sensing strip extends along at least two connected outer edges of the closure panel and/or along at least two connected outer edges of the frame.

6. The apparatus according to claim 1, wherein the at least one actuator comprises a linear actuator that moves at least one bump stop to a deployed position in response to the detected obstruction.

7. The apparatus according to claim 1, wherein the at least one actuator comprises at least one electromagnetic damper.

8. The apparatus according to claim 7, wherein the electromagnetic damper comprises a hinge that couples the first and second vehicle structures together.

9. The apparatus according to claim 1, including a control unit that receives signals from the sensing strip and generates control signals to control actuation of the actuator, and wherein the control unit immediately deploys the actuator in response to a detected obstruction.

10. An apparatus, comprising:
a vehicle panel movable relative to a frame between open and closed positions;
a sensing strip extending along an outer edge of at least one of the vehicle panel and frame to detect an obstruction between the panel and frame; and
at least one actuator that is immediately deployed in response to a detected obstruction to prevent the panel from moving to the closed position.

11. The apparatus according to claim 10, wherein the sensing strip comprises a flexible strip of electrodes that detects the obstruction based on projected capacitance.

12. The apparatus according to claim 11, including a control unit that receives signals from the sensing strip and generates control signals to control actuation of the actuator.

13. The apparatus according to claim 12, wherein the at least one actuator comprises a linear actuator that moves at least one bump stop to a deployed position in response to the detected obstruction.

14. The apparatus according to claim 12, wherein the at least one actuator comprises at least one electromagnetic damper.

15. The apparatus according to claim 12, wherein each of the panel and frame include an upper edge, lower edge, and side edges connecting the upper and lower edges, and wherein the sensing strip extends along at least the upper edge and one of the side edges of at least one of the panel and frame.

16. A method comprising:
mounting a vehicle panel for movement relative to a frame between open and closed positions;
surrounding outer edges of at least one of the vehicle panel and frame with a sensing strip to detect an obstruction between the panel and frame; and
immediately actuating an actuator in response to a detected obstruction to prevent the panel from moving to the closed position.

17. The method according to claim 16, wherein the sensing strip comprises a flexible strip of electrodes that detects the obstruction based on projected capacitance, and including extending the sensing strip along at least two connected outer edges of the panel and/or along at least two connected outer edges of the frame.

18. The method according to claim 16, including transmitting sensor signals to a control unit and generating control signals to control the actuator in response to an absence and/or presence of an obstruction.

19. The method according to claim 16, wherein the at least one actuator comprises a linear actuator that moves at least one bump stop to a deployed position in response to the detected obstruction.

20. The method according to claim 16, wherein the at least one actuator comprises at least one electromagnetic damper.
